(19) United States
(12) Patent Application Publication
(10) Pub. No.: US 2024/0070192 A1
(43) Pub. Date: Feb. 29, 2024

(54) AUDIO CONVERSION METHOD AND APPARATUS, AND AUDIO PLAYING METHOD AND APPARATUS

(71) Applicant: BEIJING BYTEDANCE NETWORK TECHNOLOGY CO., LTD., Beijing (CN)

(72) Inventors: Jiaxin XIONG, Beijing (CN); Jianxiong LI, Beijing (CN); Liang LIANG, Beijing (CN)

(21) Appl. No.: 18/271,222

(22) PCT Filed: Dec. 15, 2021
(86) PCT No.: PCT/CN2021/138324

§ 371 Date: Jul. 6, 2023

(30) Foreign Application Priority Data
Jan. 29, 2021 (CN) 202110124549.1

(51) Int. Cl. G06F 16/638; G06F 16/68; G06F 16/683

(52) U.S. Cl. CPC G06F 16/639; G06F 16/683; G06F 16/686

(57) ABSTRACT

An audio conversion method, an audio playing method and an apparatus, the method including: receiving an audio acquisition request corresponding to a target chapter (101); in response to an absence of an audio file corresponding to the target chapter, segmenting the target chapter to obtain a plurality of text segments (102); generating an audio file corresponding to each of the text segments, and determining identification information of the audio file based on a typesetting order of each of the text segments in the target chapter; storing the audio file corresponding to each of the text segments, and generating an audio list based on file information of the audio file corresponding to each of the text segments and the identification information of the audio file (103); and determining an estimated total audio playing duration corresponding to the target chapter, and sending the audio list and the estimated total audio playing duration to a user terminal (104).

### CROSS REFERENCE TO RELATED APPLICATIONS

The disclosure is the U.S. National Stage of International Application No. PCT/CN2021/138324, tided “AUDIO CONVERSION METHOD AND APPARATUS, AND AUDIO PLAYING METHOD AND APPARATUS”, filed on Dec. 15, 2021, which claims priority to Chinese Patent Application No. 202110124549.1, field on Jan. 29, 2021, titled “AUDIO CONVERSION METHOD AND APPARATUS, AND AUDIO PLAYING METHOD AND APPARATUS”, the entire contents of both of which are incorporated herein by reference.

### FIELD

The present disclosure relates to the field of computer technology, in particular, to an audio conversion method and apparatus, and audio playing method and apparatus.

### BACKGROUND

With the arrival of the information age, information sources of users are increasingly dependent on the Internet, traditional text reading has not been able to meet information acquisition needs of users, users can borrow relevant technologies to convert the text into the audio and obtain information through the audio, for example, Text-to-Speech (TTS) technology.

In related technology, when converting the text into the audio, there are generally two methods, one is offline conversion method, which converts the text into the audio in advance before a user initiates an audio acquisition request, so that the user can directly acquire the audio after initiating the audio acquisition request. However, due to the large number of texts, this method may not realize the early conversion of all texts, which may lead to the situation that the user cannot acquire the audio after initiating the audio acquisition request. The other method is online conversion, that is, after receiving the audio acquisition request initiated by the user, the text is converted into the audio and sent to the user terminal. However, this method generally sends all the texts into the audios before sending to the user terminal, which leads to a longer time spent on audio conversion and a longer waiting time for the user when the text content is large.

### SUMMARY

The summary section of the disclosure is provided to introduce in brief the concepts which will be described in detail later in the detailed description section. This summary section is not intended to identify key or necessary features of the claimed technical solution, nor is it intended to limit the scope of the claimed technical solution.

The embodiment of the disclosure at least provides an audio conversion method and apparatus, an audio playing method and an apparatus.

The first aspect of the disclosure provides an audio conversion method, comprising:
receiving an audio acquisition request corresponding to a target chapter;
in response to an absence of an audio file corresponding to the target chapter, segmenting the target chapter to obtain a plurality of text segments;
generating an audio file corresponding to each of the text segments, and determining identification information of the audio file based on a typesetting order of each of the text segments in the target chapter, and storing the audio file corresponding to each of the text segments, and generating an audio list based on file information of the audio file corresponding to each of the text segments and the identification information of the audio file; and
determining an estimated total audio playing duration corresponding to the target chapter, and sending the audio list and the estimated total audio playing duration to a user terminal.

The second aspect of the disclosure provides an audio playing method, comprising:
initiating an audio acquisition request corresponding to a target chapter to a server;
receiving an audio list and an estimated total audio playing duration corresponding to the target chapter returned by the server, and controlling a player to play an audio file corresponding to each of the text segments sequentially based on the audio list, wherein the audio list comprises file information and identification information of audio files corresponding to a plurality of text segments, and the text segments are obtained by segmenting the target chapter; and
playing the audio files based on the identification information of the audio files, and displaying audio playing progress based on the estimated total audio playing duration.

The third aspect of the disclosure provides an audio conversion apparatus, comprising:
a receiving module, configured to receive an audio acquisition request corresponding to a target chapter;
a segmentation module, configured to, in response to an absence of an audio file corresponding to the target chapter, segment the target chapter to obtain a plurality of text segments;
a generating module, configured to generate an audio file corresponding to each of the text segments, and determine identification information of the audio file based on a typesetting order of each of the text segments in the target chapter, and store the audio file corresponding to each of the text segments, and generate an audio list based on file information of the audio file corresponding to each of the text segments and the identification information of the audio file; and
a sending module, configured to determine an estimated total audio playing duration corresponding to the target chapter, and send the audio list and the estimated total audio playing duration to a user terminal.

The fourth aspect of the disclosure provides an audio playing apparatus, comprising:
a request module, configured to initiate an audio acquisition request corresponding to a target chapter to a server;
a playing module, configured to receive an audio list and an estimated total audio playing duration corresponding to the target chapter returned by the server, and control a player to play an audio file corresponding to each of the text segments sequentially based on the audio list, wherein the audio list comprises file information and identification information of audio files corresponding to a plurality of text segments, and the text segments are obtained by segmenting the target chapter; and
a display module, configured to play the audio files based on the identification information of the audio files, and display audio playing progress based on the estimated total audio playing duration.

The fifth aspect of the disclosure provides a computing device, comprising: a processor, a memory, and a bus, the memory storing machine-readable instructions executable by the processor, the processor communicating with the memory over the bus when the computing device is running, the machine-readable instructions when executed by the processor, causing the computing device to perform the steps provided in any of the embodiments of the first aspect of the disclosure, or perform the steps provided in any of the embodiments of the second aspect of the disclosure.

The sixth aspect of the disclosure provides computer-readable storage medium, storing computer program that upon execution by a processor, cause the processor to perform the steps provided in any of the embodiments of the first aspect of the disclosure, or perform the steps provided in any of the embodiments of the second aspect of the disclosure.

According to the audio conversion method, the audio playing method and the apparatus provided by the embodiment of the disclosure, the target chapter can be segmented under the condition that no audio file corresponding to the target chapter is detected, and then conversion is performed with the text segment as a unit, and an audio list is generated after the conversion is completed, the audios in the audio list are corresponding to the target chapter. After sending the audio list and the estimated total audio playing duration corresponding to the target chapter to the user terminal, the user terminal can play the audio corresponding to each of the text segments in sequence according to the audio list and display the estimated total audio playing duration. In this process, the time for the conversion of the text segment is shorter, so that the purpose of audio converting at the server while playing at the user terminal can be realized, and the waiting time of the user can be reduced. In addition, by displaying the estimated total audio playing duration, the user cannot perceive that during playback, the audio corresponding to one segmented text is followed by the audio corresponding to another segmented text, and the user can know the current playing progress through the total audio playing duration, thus improving the user experience.

In order to make the above objectives, features and advantages of the present disclosure more readily understood, preferred embodiments are set forth below and are described in detail with reference to the accompanying drawings.

### BRIEF DESCRIPTION OF DRAWINGS

In order to more clearly explain the technical solutions of the embodiments of the present disclosure, a brief introduction will be given below to the drawings required for use in the embodiments, which are incorporated herein and form a part of the description. These drawings illustrate the embodiments consistent with the present disclosure and together with the description serve to illustrate the technical solutions of the present disclosure. It should be understood that the following drawings illustrate only certain embodiments of the present disclosure and therefore should not be taken as limiting in scope, and other related drawings may be obtained from these drawings without creative effort for those of ordinary skill in the art.

FIG. 1 shows a flowchart of an audio conversion method provided by an embodiment of the present disclosure;

FIG. 2 shows a schematic flow diagram of an audio playing method provided by an embodiment of the present disclosure;

FIG. 3 shows a playing schematic diagram provided by an embodiment of the present disclosure;

FIG. 4 shows a schematic diagram of an interaction process between a user terminal and a server provided by an embodiment of the present disclosure;

FIG. 5 shows an architectural schematic diagram of an audio conversion apparatus provided by an embodiment of the present disclosure;

FIG. 6 shows an architectural schematic diagram of an audio playing apparatus provided by an embodiment of the present disclosure;

FIG. 7 shows a schematic structural diagram of a computing device 700 provided by an embodiment of the present disclosure; and

FIG. 8 shows a schematic structural diagram of a computing device 800 provided by an embodiment of the present disclosure.

### DETAILED DESCRIPTION OF THE INVENTION

In order to make the objectives, technical solutions and advantages of the disclosed embodiments clearer, the technical solutions of the disclosed embodiments will be clearly and completely described below in conjunction with the accompanying drawings of the disclosed embodiments, and it will be apparent that the described embodiments are only a part of the disclosed embodiments, not all of them. The components of the embodiments of the present disclosure generally described and illustrated in the drawings herein may be arranged and designed in a variety of different configurations. Accordingly, the following detailed description of the embodiments of the disclosure provided in the accompanying drawings is not intended to limit the scope of the claimed disclosure but is merely representative of selected embodiments of the disclosure. Based on the embodiments of the present disclosure, all other embodiments obtained by those skilled in the art without making creative effort are within the scope of protection of the present disclosure.

In related technology, there are generally two methods, one is offline conversion method, which converts the text into the audio in advance before a user initiates an audio acquisition request, so that the user can directly acquire the audio after initiating the audio acquisition request. However, due to the large number of texts, this method may not realize the early conversion of all the texts, which may lead to the situation that the user cannot acquire the audio after initiating the audio acquisition request. The other method is online conversion, that is, after receiving the audio acquisition request initiated by the user, the text is converted into the audio and sent to the user terminal. However, this method generally converts all the texts into the audios before sending to the user terminal, which leads to a longer time spent on audio conversion and a longer waiting time for the user when the text content is large.

Based on the above studies, for the audio conversion method, the audio playing method and the apparatus provided by the embodiments of the present disclosure, the target chapter can be segmented under the condition that no audio file corresponding to the target chapter is detected, and then conversion is performed with the text segment as a unit, and an audio list is generated after the conversion is completed, the audios in the audio list are the audios corresponding to the target chapter. After sending the audio list and the estimated total audio playing duration corresponding to the target chapter to the user terminal, the user terminal can play audio corresponding to each of the text segments in sequence according to the audio list and display the estimated total audio playing duration. In this process, the time for the conversion of the text segment is shorter, so that the purpose of converting at the server and playing at the user terminal can be realized, and the waiting time of the user can be reduced. In addition, by displaying the estimated total audio playing duration, the user cannot perceive that during playback, the audio corresponding to one segmented text is followed by the audio corresponding to another segmented text, and the user can know the current playing progress through the total audio playing duration, thus improving the user experience.

The defects of the above solutions are the results obtained by the inventor after practices and careful study. Therefore, the discovery process of the above problems and the solutions proposed in this disclosure below should be the inventor's contribution to this disclosure in the process of this disclosure.

It should be noted that like numerals and letters denote like items in the following drawings, and therefore, once an item is defined in one drawing, it does not need to be further defined and explained in subsequent drawings.

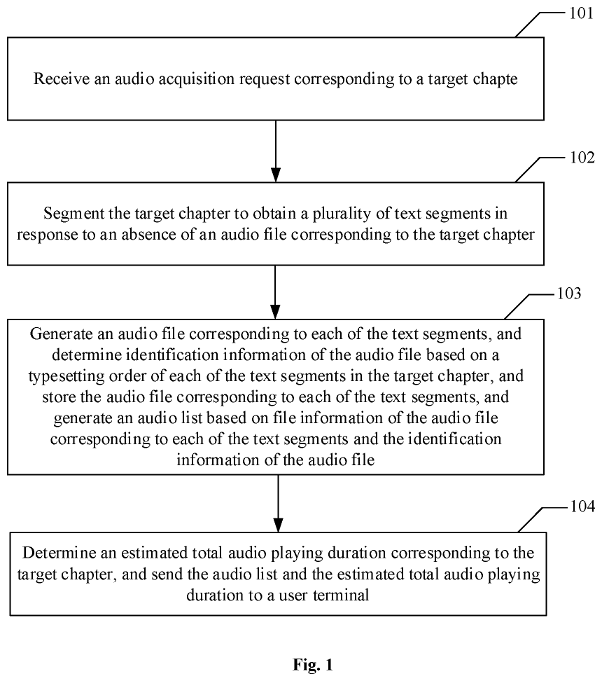

In order to facilitate the understanding of the present embodiment, firstly, an audio conversion method disclosed in an embodiment of the present disclosure is described in detail. Referring to FIG. 1 which is a flowchart of an audio conversion method provided by an embodiment of the present disclosure, the method includes steps 101 to 104:
at step 101, an audio acquisition request corresponding to a target chapter is received;
at step 102, in response to an absence of an audio file corresponding to the target chapter, the target chapter is segmented to obtain a plurality of text segments;
at step 103, an audio file corresponding to each of the text segments is generated, and identification information of the audio file is determined based on a typesetting order of each of the text segments in the target chapter, and the audio file corresponding to each of the text segments is stored, and an audio list is generated based on file information of the audio file corresponding to each of the text segments and the identification information of the audio file; and
at step 104, an estimated total audio playing duration corresponding to the target chapter is determined, and the audio list and the estimated total audio playing duration are sent to a user terminal.

The following is a detailed description of the above steps.

With regards to step 101:
the target chapter can be a certain chapter of a novel or a certain paragraph of an article. In one embodiment, the user can send an audio acquisition request corresponding to the target chapter to the server through the user terminal by triggering an audio playing button of the target chapter displayed by the user terminal (each chapter corresponds to a corresponding audio playing button). In another embodiment, the user can select the target chapter, after the target chapter is selected, a corresponding “playing” trigger button can be displayed, and after the button is triggered, an audio acquisition request corresponding to the selected target chapter can be sent to the server.

With regards to 102 and 103:

In one embodiment, the audio file corresponding to any chapter can be stored in the server after being generated. After receiving the audio acquisition request corresponding to the target chapter sent by the user terminal, whether there is a generated audio file corresponding to the target chapter can be searched from the server according to the target chapter or according to the identification information of the target chapter.

In one embodiment, when the target chapter is segmented, the target chapter is segmented based on punctuation marks in the target chapter to obtain at least one text segment, and the at least one text segment may be a segmented sentence.

For example, the target chapter can be divided into at least one sentence based on the comma, period, exclamation point, semicolon, question mark, ellipsis, etc.

In another embodiment, the target chapter may include at least one paragraph, when the target chapter is segmented, the target chapter is segmented based on line breaks into at least one text segment, and the at least one text segment may be a segmented paragraph.

In the process of segmenting the target chapter, a plurality of text segments may be obtained. In order to improve the conversion efficiency, every time a text segment is obtained, audio conversion can be performed on the text segment to obtain the audio file corresponding to the text segment.

In one embodiment, in generation of the audio file corresponding to each of the text segments, each of the text segments may be sent to an audio conversion server so that the audio conversion server generates a corresponding audio file based on each of the text segments, and then the audio file corresponding to each of the text segments returned by the audio conversion server is received.

Here, when each of the text segments is obtained, the text segment can be sent to an audio conversion server. The audio conversion server can sequentially perform audio conversion according to the order in which the text segment is received, and after the conversion is completed, the converted audio file is sent to an electronic device executing the present solution, which is generally referred to as a server here.

In another embodiment, the electronic device itself can also have an audio conversion function. After the target chapter is segmented, the text segment can be converted based on its own audio conversion function to obtain an audio file corresponding to the text segment.

In practical application, the user can directly carry out audio playing after initiating an audio playing request, so the segmentation processing is not perceptible to the user. In one embodiment, when it is detected that the target chapter does not have a corresponding generated audio file, the estimated total audio playing duration corresponding to the target chapter can be determined based on the number of characters contained in the target chapter, and then the estimated total audio playing duration can be sent to the user terminal, so that the user terminal can control the playing of the audio file corresponding to the target chapter based on the estimated total audio playing duration, for example, the fast-forward of the audio file can be controlled, etc. The specific control method will be described in detail in the audio playing method below, and will not be explained here.

In one embodiment, when determining the estimated total duration of the audio file corresponding to the target chapter based on the number of characters contained in the target chapter, the number of characters contained in the target chapter can be multiplied by a preset parameter value, and the multiplication result can be taken as the estimated total audio playing duration.

In another embodiment, the user can also choose to acquire different types of voice, such as Women's voice, children's voice, men's voice, etc. Different types of voices may have different reading speeds for texts. When determining the estimated total duration of the audio file corresponding to the target chapter based on the number of characters contained in the target chapter, the target voice type selected by the user can also be determined, and then the estimated total audio playing duration corresponding to the target chapter can be determined based on the number of characters contained in the target chapter and the reading speed coefficient corresponding to the target voice type.

In one embodiment, after receiving the audio file corresponding to the text segment sent by the audio conversion server, the received audio file may be stored in the server, or the received audio file may be sent to a Content Delivery Network (CDN) server to store the audio file corresponding to the text segment in the CDN server.

Here, the file information of the audio file corresponding to the text segment includes a storage location of the audio file, which may include, for example, a storage location of the audio file in a server executing the present solution or a storage location in the CDN server.

After the audio file corresponding to the text segment is stored, an audio list can be generated based on the file information of the audio file corresponding to each of the text segments and the identification information of the audio file. Specifically, the identification information of the audio file can be added to the audio list based on the typesetting order, and a link pointing to the storage location of the audio file in the content delivery network server is added to the identification information of the audio file, so that the audio file can be acquired from the corresponding storage location when the identification information of the audio file is triggered.

When identification information of an audio file is determined based on the typesetting order of each of the text segments in the target chapter, the order of the text segment in the target chapter can be determined as the identification information of the audio file corresponding to the text segment for any text segment. For example, if the target chapter is divided into four text segments A, B, C and D, the identification information of the audio file corresponding to the text segment A is 1, the identification information of the audio file corresponding to the text segment B is 2, the identification information of the audio file corresponding to the text segment C is 3, and the identification information of the audio file corresponding to the text segment D is 4.

In one possible implementation mod, the audio list may also store the file length of the audio file, i.e., the time required to play the audio.

In practical applications, the amount of text content corresponding to the text segment may be different, and it takes a certain amount of time to convert the audio file corresponding to the text segment. For example, if the first text segment is “first”, the duration of the audio file corresponding to the first text segment is short, and after the audio file corresponding to the first text segment is played, when there are no other audio files of the text segments that have been generated, this situation will cause playing jamming.

Therefore, in order to ensure that after the audio file corresponding to the first text segment is played, other audio file corresponding to the text segment after the first text segment is available, the audio file corresponding to the first segmented content can be combined with other audio files.

In one embodiment, after receiving the audio file corresponding to the first text segment sent by the audio conversion server, the duration of the audio file corresponding to the first text segment can also be detected, and when the duration of the audio file corresponding to the first text segment is detected to be less than a predetermined threshold, the audio file corresponding to the first text segment and the audio file corresponding to the text segment after the first text segment are combined.

Specifically, if the duration of the audio file corresponding to the first text segment is less than the predetermined threshold, the audio file corresponding to the first text segment and the audio file corresponding to the second text segment can be combined, and the combined audio file can be taken as the first audio file, and if the duration of combined audio file is not less than the predetermined threshold, the combined audio file can be stored. If the duration of the combined audio file is less than the predetermined threshold, the combined audio file can be combined with the audio file corresponding to the third text segment, and so on, until the duration of the combined audio file is not less than the predetermined threshold.

With regards to step 104:

After the audio list containing the storage address of the audio file is sent to the user terminal, a polling indication information carrying a polling interval can be sent to the user terminal, and then the audio list can be updated based on the audio file generated in real time; after receiving the polling request sent by the user terminal, the updated audio list can be sent to the user terminal.

As an example, when a server first sends an audio list to a user terminal, the audio list may include only the audio file of the first text segment and the audio file of the second text segment, and then after sending the audio list, the server may send polling indication information to the user terminal to indicate that the user terminal may initiate a polling request. When the server receives the audio file of the third text segment and the audio file of the fourth text segment within a time interval between transmitting the polling indication information to receiving the polling request initiated by the user terminal, the generated audio list may be updated based on the file information and identification information of the audio file of the third text segment and the audio file of the fourth text segment, and after receiving the polling request initiated by the user terminal, the updated audio list may be transmitted to the user terminal.

After the user terminal initiates the polling request again, the audio list can be updated based on the storage result of the audio file of the text segment received between the two polling requests, and the latest updated audio list can be sent to the user terminal.

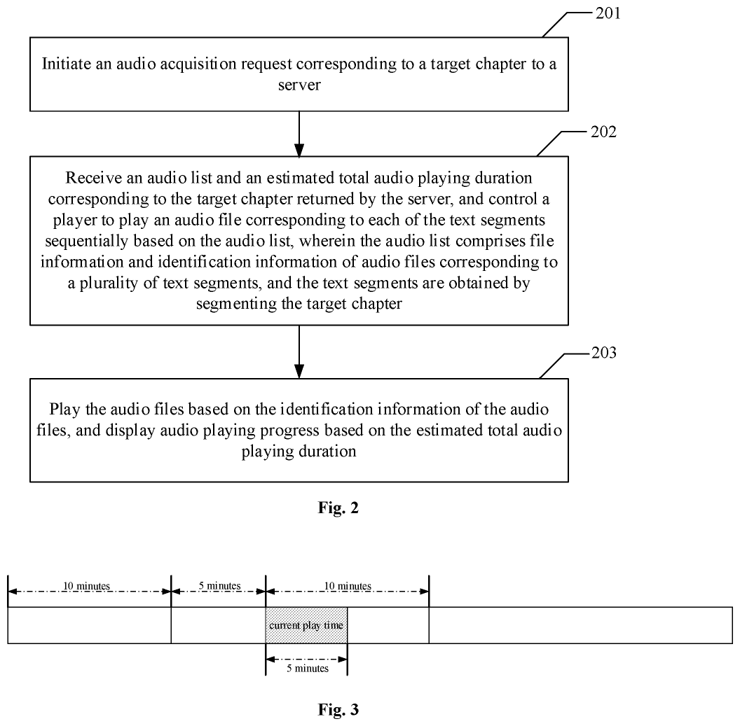

Based on the same concept, the embodiment of the present disclosure also provides an audio playing method. Referring to FIG. 2 which is a flow diagram of an audio playing method provided by an embodiment of the present disclosure, the method is applied to a user terminal, and includes the following steps:
at step S201, an audio acquisition request corresponding to a target chapter is initiated to a server;
at step S202, an audio list and an estimated total audio playing duration corresponding to the target chapter returned by the server are received, and a player is controlled to play an audio file corresponding to each of the text segments sequentially based on the audio list, wherein the audio list comprises file information and identification information of audio files corresponding to a plurality of text segments, and the text segments are obtained by segmenting the target chapter; and
at step S203, the audio files are played based on the identification information of the audio files, and audio playing progress is displayed based on the estimated total audio playing duration.

In one embodiment, in order to ensure the fluency in the playing process of a plurality of audio files, the audio file can be pre-downloaded to the local user terminal based on the storage address of the audio file in the audio list. When the audio files are played based on the identification information of the audio files, the target audio file to be played can be determined first, and then whether the target audio file has been pre-downloaded to the local user terminal is detected. If the target audio file has been downloaded to the local user terminal, the target audio file can be played based on the storage address of the target audio file at the local user terminal. If not, the corresponding target audio file can be obtained based on the storage location of the target audio file, and then the target audio file can be played.

In one embodiment, when playing the first audio file in the audio list, generally, the user terminal has not pre-downloaded the first audio file, then the first audio file can be obtained based on the storage address of the first audio file in the server and played. In the playing process of the first audio file, the audio file after the first audio file in the audio list can be pre-downloaded to the local user terminal.

In one embodiment, the user terminal may also receive an estimated total audio playing duration corresponding to the target chapter sent by the server, and then display the audio playing progress based on the estimated total audio playing duration.

Specifically, the first duration of the audio file that has been played and the second current play time of the audio file being played currently can be determined firstly; then a played time length is determined based on the first duration and the second current play time; and then, based on the played time length and the estimated total audio playing duration, the audio playing progress is displayed.

In one embodiment, when displaying the audio playing progress based on the played time length and the estimated total audio playing duration, the audio playing progress can be displayed under the condition that the received audio list includes the file information and identification information of the audio files corresponding to a part of the text segments of the target chapter. When the received audio list includes the file information and identification information of the audio files corresponding to all the text segments of the target chapter, a standard duration corresponding to the target chapter is determined based on the duration of the audio files corresponding to all the text segments. The audio playing progress is displayed based on the played time length and the standard duration.

Here, the standard duration is the time required for actually playing all the audio files corresponding to the target chapter.

In one embodiment, after the audio playing progress is displayed according to the estimated total audio playing duration and identification information of the currently played target file, the playing progress of the audio file being played currently can also be adjusted in response to a triggering operation for the audio playing progress.

Specifically, a playback time point corresponding to an end operation point of the triggering operation is determined first; if detecting that the audio file corresponding to the playback time point is comprised in the audio list, a first target playback time point of the playback time point in the audio file corresponding to the playback time point is determined; and the player is controlled to start playing the audio file corresponding to the playback time point from the first target playback time point.

The triggering operation includes, but is not limited to, a click operation, a drag operation, a double-click operation, and the like.

Specifically, when detecting whether the audio list contains the audio file corresponding to the playback time point, the duration corresponding to at least one audio file in the audio list can be determined firstly, and then whether the audio list contains the audio file corresponding to the playback time point is detected based on the duration corresponding to at least one audio file in the audio list.

As an example, the audio list includes five audio files, and the corresponding duration are 1 minute 30 seconds, 2 minutes, 2 minutes 10 seconds, 2 minutes and 1 minute respectively, then the total duration of the audio files in the audio list is 8 minutes 40 seconds. If the playback time point is 5 minutes, the audio list includes the audio file corresponding to playback time point, and the corresponding audio file is the third audio file.

When determining the first target playback time point of the playback time point in the audio file corresponding to the playback time point, the first target playback time point can be determined based on the playing time corresponding to the audio file before the audio file corresponding to the playback time point and the playback time point.

Continuing the above example, the audio file corresponding to the playback time point is the third audio file in the audio list, the duration of the two audio files before the third audio file are 1 minute 30 seconds and 2 minutes respectively, the duration of the two audio files before the third audio file is 3 minutes 30 seconds in total, since the playback time point is 5 minutes, 1 minute 30 seconds of the third audio file can be taken as the first target playback time point.

In another embodiment, when it is detected that the audio list does not contain the audio file corresponding to the playback time point, it is indicated that the audio file corresponding to the playback time point may not be generated. In this case, the audio file can be played based on the playing progress before the triggering operation is executed.

Specifically, a corresponding second target moment before executing the triggering operation can be determined, and then the player can be controlled to play from the second target playback time point.

In one embodiment, after displaying the audio playing progress based on the estimated total audio playing duration, the playing information fed back by the player every predetermined threshold can also be received. The playing information can include the total duration of the audio file currently being played and the played time length of the audio file currently being played. Based on the playing information fed back by the player, the progress display of a playing progress bar can be controlled. [00%] For example, as shown in FIG. 3, the audio list includes a plurality of audio files and the playing order of the audio files. During the playing process, the player can feed back the current play time and the duration of the audio file being played currently, but the player cannot know the overall playing progress for all the audio files. If the player feeds back that the current play time is 5 minutes and the duration is 10 minutes and the total duration of the audio files before the audio file being played currently is 10 minutes+5 minutes=15 minutes, then a played time length displayed by the progress bar can be 20 minutes, and the total duration is the estimated total audio playing duration sent by the server.

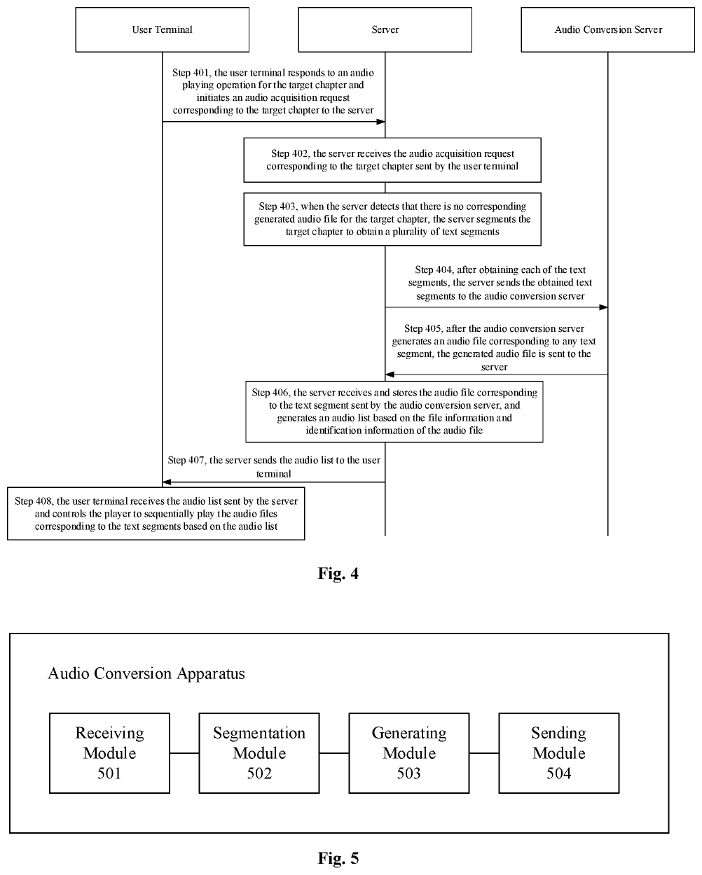

Combined with the above audio conversion method and audio playing method, the interaction process between the server and the user terminal will be introduced below. Referring to FIG. 4 which is a schematic diagram of an interaction process between a user terminal and a server provided by an embodiment of the present disclosure, the interaction process includes the following steps:

At step 401, the user terminal responds to an audio playing operation for the target chapter and initiates an audio acquisition request corresponding to the target chapter to the server.

At step 402, the server receives the audio acquisition request corresponding to the target chapter sent by the user terminal.

At step 403, when the server detects that there is no corresponding generated audio file for the target chapter, the server segments the target chapter to obtain a plurality of text segments.

At step 404, after obtaining each of the text segments, the server sends the obtained text segments to the audio conversion server.

At step 405, after the audio conversion server generates an audio file corresponding to any text segment, the generated audio file is sent to the server.

At step 406, the server receives and stores the audio file corresponding to the text segment sent by the audio conversion server, and generates an audio list based on the file information and identification information of the audio file.

At step 407, the server sends the audio list to the user terminal.

At step 408, the user terminal receives the audio list sent by the server and controls the player to sequentially play the audio files corresponding to the text segments based on the audio list.

Those skilled in the art will appreciate that in the above-described method of the specific implementation mode, the sequence of writing of the steps does not imply a strict sequence of execution and does not constitute any limitation on the implementation process, and the specific sequence of execution of the steps should be determined by their functions and possible inherent logic.

According to the audio conversion method and the audio playing method provided by the embodiments of the disclosure, under the condition that there is no generated audio file in the target chapter, the chapter can be segmented, and then the audio conversion server can convert the text segment as a unit, and after the conversion is completed, audio files are sent to the user terminal for playing through the server. In this process, the time for converting the text segment is shorter, so that the purpose of converting at the audio conversion server and playing at the user terminal can be realized, the waiting time of the user is reduced, and the user experience is improved.

Based on the same inventive concept, the embodiment of the present disclosure also provides an audio conversion apparatus corresponding to the audio conversion method. Since the problem solving principle of the apparatus in the embodiment of the present disclosure is similar to that of the audio conversion method of the embodiment of the present disclosure, the implementation of the apparatus can refer to the implementation of the method, and the repetitions will not be repeated here.

Referring to FIG. 5 which is an architectural schematic diagram of an audio conversion apparatus provided by an embodiment of the present disclosure, the apparatus includes a receiving module 501, a segmentation module 502, a generating module 503, and a sending module 504, wherein
the receiving module 501 is configured to receive an audio acquisition request corresponding to a target chapter;
the segmentation module 502 is configured to, in response to an absence of an audio file corresponding to the target chapter, segment the target chapter to obtain a plurality of text segments;
the generating module 503 is configured to generate an audio file corresponding to each of the text segments, and determine identification information of the audio file based on the typesetting order of each of the text segments in the target chapter; store the audio file corresponding to each of the text segments, and generate an audio list based on file information of the audio file corresponding to each of the text segments and the identification information of the audio file; and
the sending module 504 is configured to determine an estimated total audio playing duration corresponding to the target chapter, and send the audio list and the estimated total audio playing duration to a user terminal.

In one embodiment, the segmentation module 502, when segmenting the target chapter to obtain a plurality of text segments, is configured for:
segmenting the target chapter based on punctuation marks or line breaks in the target chapter to obtain the plurality of text segments.

In one embodiment, the generating module 503, when generating an audio file corresponding to each of the text segments, is configured for:
sending each of the text segments to an audio conversion server so that the audio conversion server generates a corresponding audio file based on each of the text segments; and
receiving the audio file corresponding to each of the text segments returned by the audio conversion server, and sending the received audio file to a content delivery network server so that the content delivery network server stores the audio file.

In one embodiment, the file information of the audio file corresponding to the text segment comprises a storage location of the audio file in the content delivery network server,
and the generating module 503, when generating an audio list based on file information of the audio file corresponding to each of the text segments and the identification information of the audio file, is configured for:
adding the identification information of the audio file to the audio list based on the typesetting order, and adding a link pointing to the storage location of the audio file in the content delivery network server for the identification information of the audio file, so that the audio file is acquired from the corresponding storage location when the identification information of the audio file is triggered.

In one embodiment, the generating module 503, after generating an audio file corresponding to each of the text segments, is configured for:
in response to detecting that a duration of the audio file corresponding to the first text segment is less than a predetermined threshold, combining the audio file corresponding to the first text segment with the audio file corresponding to the text segment after the first text segment.

In one embodiment, the sending module 504, when determining an estimated total audio playing duration corresponding to the target chapter, is configured for:
determining an estimated total duration of the audio files corresponding to the target chapter based on the number of characters contained in the target chapter.

In one embodiment, the sending module 504, when determining an estimated total duration of the audio files corresponding to the target chapter based on the number of characters contained in the target chapter, is configured for:
determining a target voice type selected by a user terminal; and
based on the number of characters contained in the target chapter and a reading speed coefficient corresponding to the target voice type, determining the estimated total duration of the audio files corresponding to the target chapter.

In one embodiment, after the sending the audio list and the estimated total audio playing duration to a user terminal, the sending module 504 is further configured for:
sending polling indication information to the user terminal, and updating the audio list based on the audio file generated in real time; and
after receiving a polling request sent by the user terminal, sending the updated audio list to the user terminal.

The description of the processing flow of the modules in the device, and the interaction flow between the modules can be referred to the relevant descriptions in the method embodiments described above, and will not be described in detail here.

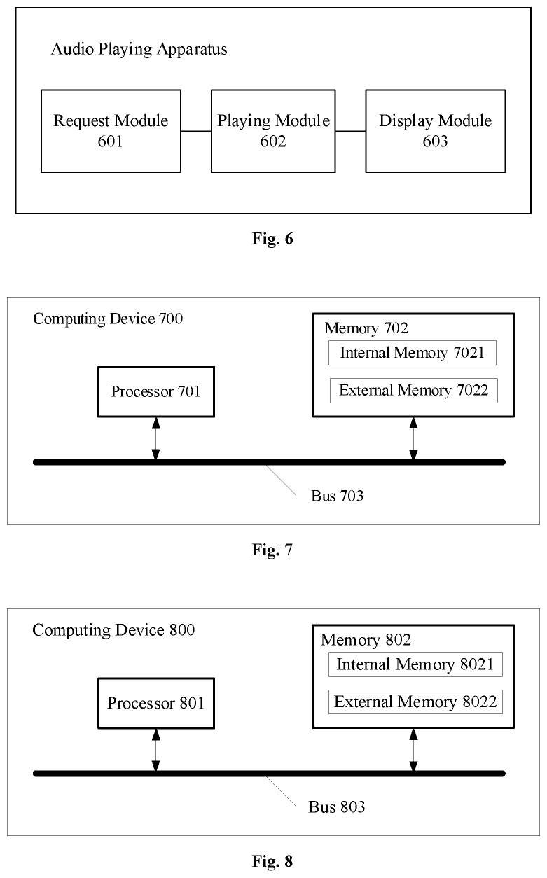

Referring to FIG. 6, which is an architectural schematic diagram of an audio conversion apparatus provided by an embodiment of the present disclosure, the apparatus includes a request module 601, a playing module 602, and a display module 603, wherein
the request module 601 is configured to initiate an audio acquisition request corresponding to a target chapter to a server;
the playing module 602 is configured to receive an audio list and an estimated total audio playing duration corresponding to the target chapter returned by the server, and control a player to play an audio file corresponding to each of the text segments sequentially based on the audio list, wherein the audio list comprises file information and identification information of audio files corresponding to a plurality of text segments, and the text segments are obtained by segmenting the target chapter; and
the display module 603 is configured to play the audio files based on the identification information of the audio files, and display audio playing progress based on the estimated total audio playing duration.

In one embodiment, the file information of the audio file corresponding to the text segment comprises a storage location of the audio file corresponding to the text segment, and
the playing module 602, when playing the audio files based on the identification information of the audio file, is configured for:
determining a target audio file to be played;
detecting if the target audio file has been pre-downloaded to a local user terminal;
if so, playing the target audio file based on a storage address of the target audio file at the user terminal; and
if not, acquiring a corresponding target audio file based on the storage location of the target audio file, and playing the target audio file.

In one embodiment, the display module 603, when displaying the audio playing progress based on the estimated total audio playing duration, is configured for:
determining a first duration of an audio file that has been played and a second current play time of an audio file being played currently;
determining a played time length based on the first duration and the second current play time; and
displaying the audio playing progress based on the played time length and the estimated total audio playing duration.

In one embodiment, the display module 603, when displaying audio playing progress based on the played time length and the estimated total audio playing duration, is configured for:
if the audio list received comprises file information and identification information of the audio files corresponding to a part of the text segments of the target chapter, displaying the audio playing progress based on the played time length and the estimated total audio playing duration, and
the display module 603 is further configured for:
if the audio list received comprises file information and identification information of the audio files corresponding to all the text segments of the target chapter, determining a standard duration corresponding to the target chapter based on the duration of the audio files corresponding to all the text segments; and
displaying the audio playing progress based on the played time length and the standard duration.

In one embodiment, after the displaying audio playing progress based on the estimated total audio playing duration, the display module 603 is further configured for:
adjusting the playing progress of the audio file being played currently in response to a triggering operation for the audio playing progress.

In one embodiment, the display module 603, when adjusting the playing progress of the audio file being played currently in response to a triggering operation for the audio playing progress, is configured for:
determining a playback time point corresponding to an end operation point of the triggering operation;
if detecting that the audio file corresponding to the playback time point is comprised in the audio list, determining a first target playback time point corresponding to the playback time point in the audio file corresponding to the playback time point; and
controlling the player to start playing the audio file corresponding to the playback time point from the first target playback time point.

In one embodiment, if detecting that the audio file corresponding to the playback time point is not comprised in the audio list, the display module 603 is further configured for:
playing the audio file based on the playing progress before the triggering operation is executed.

The description of the processing flow of the modules in the device, and the interaction flow between the modules can be referred to the relevant descriptions in the method embodiments described above, and will not be described in detail here.

According to the audio conversion apparatus and the audio playing apparatus provided by the embodiments of the present disclosure, the target chapter can be segmented under the condition that no audio file corresponding to the target chapter is detected, and then conversion is performed with the text segment as a unit, and an audio list is generated after the conversion is completed, the audios in the audio list are the audios corresponding to the target chapter. After sending the audio list and the estimated total audio playing duration corresponding to the target chapter to the user terminal, the user terminal can play each of the text segments in sequence according to the audio list and display the estimated total audio playing duration. In this process, the time for the conversion of the text segment is shorter, so that the purpose of converting at the server and playing at the user terminal can be realized, and the waiting time of the user can be reduced. In addition, by displaying the estimated total audio playing duration, the user cannot perceive that during playback, the audio corresponding to one segmented text is followed by the audio corresponding to another segmented text, and the user can know the current playing progress through the total audio playing duration, thus improving the user experience.

Based on the same technical contemplation, embodiments of the disclosure also provide a computing device. Referring to FIG. 7, a schematic diagram of the structure of a computing device 700 provided by embodiments of the disclosure includes a processor 701, a memory 702, and a bus 703. The memory 702 is used to store instructions and includes an internal memory 7021 and an external memory 7022. The internal memory 7021, also referred to as an internal storage, is used to temporarily store data in the processor 701, and data exchanged with external memory 7022 such as a hard disk, and the processor 701 exchanges data with the external memory 7022 through the internal memory 7021, and when the computing device 700 is operating, the processor 701 communicates with the memory 702 through the bus 703 such that the processor 701 is executing the following instructions:
receiving an audio acquisition request corresponding to a target chapter;
in response to an absence of an audio file corresponding to the target chapter, segmenting the target chapter to obtain a plurality of text segments;
generating an audio file corresponding to each of the text segments, and determining identification information of the audio file based on a typesetting order of each of the text segments in the target chapter, and storing the audio file corresponding to each of the text segments, and generating an audio list based on file information of the audio file corresponding to each of the text segments and the identification information of the audio file; and
determining an estimated total audio playing duration corresponding to the target chapter, and sending the audio list and the estimated total audio playing duration to a user terminal.

In one embodiment, with respect to the instructions executed by processor 701, the segmenting the target chapter to obtain a plurality of text segments, comprising:
segmenting the target chapter based on punctuation marks or line breaks in the target chapter to obtain the plurality of text segments.

In one embodiment, with respect to the instructions executed by processor 701, the generating an audio file corresponding to each of the text segments comprises:
sending each of the text segments to an audio conversion server so that the audio conversion server generates a corresponding audio file based on each of the text segments; and
receiving the audio file corresponding to each of the text segments returned by the audio conversion server, and sending the received audio file to a content delivery network server so that the content delivery network server stores the audio file.

In one embodiment, with respect to the instructions executed by processor 701, the file information of the audio file corresponding to the text segment comprises a storage location of the audio file in the content delivery network server,
and the generating an audio list based on file information of the audio file corresponding to each of the text segments and the identification information of the audio file comprises:
adding the identification information of the audio file to the audio list based on the typesetting order, and adding a link pointing to the storage location of the audio file in the content delivery network server for the identification information of the audio file, so that the audio file is acquired from the corresponding storage location when the identification information of the audio file is triggered.

In one embodiment, with respect to the instructions executed by processor 701, after generating an audio file corresponding to each of the text segments, the method further comprises:
in response to detecting that a duration of the audio file corresponding to the first text segment is less than a predetermined threshold, combining the audio file corresponding to the first text segment with the audio file corresponding to the text segment after the first text segment.

In one embodiment, with respect to the instructions executed by processor 701, the determining an estimated total audio playing duration corresponding to the target chapter comprises:
determining an estimated total duration of the audio files corresponding to the target chapter based on the number of characters contained in the target chapter.

In one embodiment, with respect to the instructions executed by processor 701, the determining an estimated total duration of the audio files corresponding to the target chapter based on the number of characters contained in the target chapter comprises:
determining a target voice type selected by a user terminal; and
based on the number of characters contained in the target chapter and a reading speed coefficient corresponding to the target voice type, determining the estimated total duration of the audio files corresponding to the target chapter.

In one embodiment, with respect to the instructions executed by processor 701, after the sending the audio list and the estimated total audio playing duration to a user terminal, the method further comprises:
sending polling indication information to the user terminal, and updating the audio list based on the audio file generated in real time; and
after receiving a polling request sent by the user terminal, sending the updated audio list to the user terminal.

Based on the same technical concept, the embodiment of the present disclosure also provides a computing device. Referring to FIG. 8 which is a schematic structural diagram of a computing device 800 provided by an embodiment of the present disclosure, the computing device includes a processor 801, a memory 802, and a bus 803. The memory 802 is used for storing execution instructions and includes an internal memory 8021 and an external memory 8022. The internal memory 8021 is also referred to as the internal storage and is used for temporarily storing operation data in the processor 801 and data exchanged with an external memory 8022 such as a hard disk. The processor 801 exchanges data with the external memory 8022 through the internal memory 8021. When the computing device 800 is running, the processor 801 communicates with the memory 802 through the bus 803, so that the processor 801 executes the following instructions:
initiating an audio acquisition request corresponding to a target chapter to a server;
receiving an audio list and an estimated total audio playing duration corresponding to the target chapter returned by the server, and controlling a player to play an audio file corresponding to each of the text segments sequentially based on the audio list; wherein the audio list comprises file information and identification information of audio files corresponding to a plurality of text segments, and the text segments are obtained by segmenting the target chapter; and
playing the audio files based on the identification information of the audio files, and displaying audio playing progress based on the estimated total audio playing duration.

In one embodiment, with respect to the instructions executed by processor 801, the file information of the audio file corresponding to the text segment comprises a storage location of the audio file corresponding to the text segment, and
the playing the audio files based on the identification information of the audio files comprises:
determining a target audio file to be played;
detecting if the target audio file has been pre-downloaded to a local user terminal;
if so, playing the target audio file based on a storage address of the target audio file at the user terminal; and
if not, acquiring a corresponding target audio file based on the storage location of the target audio file, and playing the target audio file.

In one embodiment, with respect to the instructions executed by processor 801, the displaying the audio playing progress based on the estimated total audio playing duration comprises:
determining a first duration of an audio file that has been played and a second current play time of an audio file being played currently;
determining a played time length based on the first duration and the second current play time; and
displaying the audio playing progress based on the played time length and the estimated total audio playing duration.

In one embodiment, with respect to the instructions executed by processor 801, the displaying audio playing progress based on the played time length and the estimated total audio playing duration comprises:
if the audio list received comprises file information and identification information of the audio files corresponding to a part of the text segments of the target chapter, displaying the audio playing progress based on the played time length and the estimated total audio playing duration, and
the method further comprises:
if the audio list received comprises file information and identification information of the audio files corresponding to all the text segments of the target chapter, determining a standard duration corresponding to the target chapter based on the duration of the audio files corresponding to all the text segments; and
displaying the audio playing progress based on the played time length and the standard duration.

In one embodiment, with respect to the instructions executed by processor 801, after the displaying audio playing progress based on the estimated total audio playing duration, the method further comprises:
adjusting the playing progress of the audio file being played currently in response to a triggering operation for the audio playing progress.

In one embodiment, with respect to the instructions executed by processor 801, the adjusting the playing progress of the audio file being played currently in response to a triggering operation for the audio playing progress comprises:
determining a playback time point corresponding to an end operation point of the triggering operation;
if detecting that the audio file corresponding to the playback time point is comprised in the audio list, determining a first target playback time point corresponding to the playback time point in the audio file corresponding to the playback time point; and
controlling the player to start playing the audio file corresponding to the playback time point from the first target playback time point.

In one embodiment, with respect to the instructions executed by processor 801, if detecting that the audio file corresponding to the playback time point is not comprised in the audio list, the method further comprises:
playing the audio file based on the playing progress before the triggering operation is executed.

One embodiment of the disclosure further provides a computer readable storage medium, storing computer program that upon execution by a processor, cause the processor to perform the steps of the audio conversion method and audio playing method described in the embodiments above. The storage medium may be a volatile or non-volatile computer readable storage medium.

The computer program product for the audio conversion method and audio playing method provided by embodiments of the disclosure includes a computer readable storage medium on which program code is stored, said program code comprising instructions that can be used to perform the steps of the audio conversion method and audio playing method described in the method embodiments above, which will not be repeated herein.

One embodiment of the disclosure further provides a computer program that implements any of the methods of the preceding embodiments when executed by a processor. The computer program product may be specifically implemented by means of hardware, software, or a combination thereof. In one optional embodiment, said computer program product is embodied specifically as a computer storage medium, and in another optional embodiment, the computer program product is embodied specifically as a software product, such as a Software Development Kit (SDK), and the like.

Those skilled in the art can clearly understand that, for the convenience and simplicity of description, the specific working process of the above-described system and apparatus may refer to the corresponding process in the aforementioned method embodiments, and will not be repeated herein. In several embodiments provided in the disclosure, the disclosed system, apparatus, and method may be implemented in other ways. The above-described apparatus embodiments are only schematic. For example, dividing of the units is only a kind of logical function dividing, and there may be other dividing modes in actual implementation. For another example, the plurality of units or components can be combined or integrated into another system, or some features can be ignored or not executed. On the other hand, the mutual coupling or direct coupling or communication connection shown or discussed may be indirect coupling or communication connection through some communication interfaces, apparatuses, or units, and may be electrical, mechanical or in other forms.

The units or modules described as separate parts may or may not be physically separated, and the parts displayed as units may or may not be physical units, that is, they may be in one place or distributed onto a plurality of network units. Part or all of the units or modules can be selected according to actual needs to implement the objectives of the solutions of the present embodiment.

In addition, each functional unit in each embodiment of the disclosure may be integrated into one processing unit, or each unit may exist physically alone, or two or more units may be integrated into one unit.

The function, if implemented in the form of a software functional unit and sold or used as an independent product, may be stored in a nonvolatile computer readable storage medium that can be executed by a processor. Based on this understanding, the technical solutions of the disclosure essentially, or parts contributing to the prior art, or part of the technical solutions can be embodied in a software product form. A computer software product is stored in a storage medium, including a plurality of instructions used to cause an electronic device (may be a personal computer, a server, a network device, etc.) to execute all or part of the steps of the methods in all the embodiments of the disclosure. The aforementioned storage medium includes: a U disk, a mobile hard disk, a read-only memory (ROM), a random-access memory (RAM), a magnetic disk or an optical disk and other media that can store program codes.

Finally, it should be noted that the above embodiments are only specific implementations of the disclosure and are used to illustrate the technical solutions of the disclosure but not limit it. The protection scope of the disclosure is not limited to this. Although the disclosure has been illustrated in detail with reference to the aforementioned embodiments, those skilled in the art should understand that: any person skilled in the art can still modify or easily think of changes to the technical solutions recorded in the aforementioned embodiments, or make equivalent replacement for part of the technical features thereinto within the technical scope disclosed in the disclosure. However, these modifications, changes or replacements do not make the nature of the corresponding technical solutions separate from the spirit and scope of the technical solutions of the embodiments of the disclosure, and should be covered the protection scope of the disclosure. Therefore, the protection scope of the disclosure should be subjected to the protection scope of the claims.

1. An audio conversion method, comprising:
receiving an audio acquisition request corresponding to a target chapter;
in response to an absence of an audio file corresponding to the target chapter, segmenting the target chapter to obtain a plurality of text segments;
generating an audio file corresponding to each of the text segments, and determining identification information of the audio file based on a typesetting order of each of the text segments in the target chapter, and storing the audio file corresponding to each of the text segments, and generating an audio list based on file information of the audio file corresponding to each of the text segments and the identification information of the audio file; and
determining an estimated total audio playing duration corresponding to the target chapter, and sending the audio list and the estimated total audio playing duration to a user terminal.

2. The method according to claim 1, wherein the segmenting the target chapter to obtain a plurality of text segments, comprising:
segmenting the target chapter based on punctuation marks or line breaks in the target chapter to obtain the plurality of text segments.

3. The method according to claim 1, wherein the generating an audio file corresponding to each of the text segments comprises:
sending each of the text segments to an audio conversion server so that the audio conversion server generates a corresponding audio file based on each of the text segments; and
receiving the audio file corresponding to each of the text segments returned by the audio conversion server, and sending the received audio file to a content delivery network server so that the content delivery network server stores the audio file.

4. The method according to claim 3, wherein the file information of the audio file corresponding to the text segment comprises a storage location of the audio file in the content delivery network server,
and wherein the generating an audio list based on file information of the audio file corresponding to each of the text segments and the identification information of the audio file comprises:
adding the identification information of the audio file to the audio list based on the typesetting order, and adding a link pointing to the storage location of the audio file in the content delivery network server for the identification information of the audio file, so that the audio file is acquired from the corresponding storage location when the identification information of the audio file is triggered.

5. The method according to claim 1, wherein after generating an audio file corresponding to each of the text segments, the method further comprises:
in response to detecting that a duration of the audio file corresponding to the first text segment is less than a predetermined threshold, combining the audio file corresponding to the first text segment with the audio file corresponding to the text segment after the first text segment.

6. The method according to claim 1, wherein the determining an estimated total audio playing duration corresponding to the target chapter comprises:
determining an estimated total duration of the audio files corresponding to the target chapter based on the number of characters contained in the target chapter.

7. The method according to claim 6, wherein the determining an estimated total duration of the audio files corresponding to the target chapter based on the number of characters contained in the target chapter comprises:
determining a target voice type selected by a user terminal; and
based on the number of characters contained in the target chapter and a reading speed coefficient corresponding to the target voice type, determining the estimated total duration of the audio files corresponding to the target chapter.

8. The method according to claim 1, wherein after the sending the audio list and the estimated total audio playing duration to a user terminal, the method further comprises:
sending polling indication information to the user terminal, and updating the audio list based on the audio file generated in real time; and
after receiving a polling request sent by the user terminal, sending the updated audio list to the user terminal.

9. An audio playing method, comprising:
initiating an audio acquisition request corresponding to a target chapter to a server;
receiving an audio list and an estimated total audio playing duration corresponding to the target chapter returned by the server, and controlling a player to play an audio file corresponding to each of the text segments sequentially based on the audio list, wherein the audio list comprises file information and identification information of audio files corresponding to a plurality of text segments, and the text segments are obtained by segmenting the target chapter; and
playing the audio files based on the identification information of the audio files, and displaying audio playing progress based on the estimated total audio playing duration.

10. The method according to claim 9, wherein the file information of the audio file corresponding to the text segment comprises a storage location of the audio file corresponding to the text segment, and
wherein the playing the audio files based on the identification information of the audio files comprises:
determining a target audio file to be played;
detecting if the target audio file has been pre-downloaded to a local user terminal;
if so, playing the target audio file based on a storage address of the target audio file at the user terminal; and
if not, acquiring a corresponding target audio file based on the storage location of the target audio file, and playing the target audio file.

11. The method according to claim 9, wherein the displaying the audio playing progress based on the estimated total audio playing duration comprises:
determining a first duration of an audio file that has been played and a second current play time of an audio file being played currently;
determining a played time length based on the first duration and the second current play time; and
displaying the audio playing progress based on the played time length and the estimated total audio playing duration.

12. The method according to claim 11, wherein the displaying audio playing progress based on the played time length and the estimated total audio playing duration comprises:
if the audio list received comprises file information and identification information of the audio files corresponding to a part of the text segments of the target chapter, displaying the audio playing progress based on the played time length and the estimated total audio playing duration, and
wherein the method further comprises:
if the audio list received comprises file information and identification information of the audio files corresponding to all the text segments of the target chapter, determining a standard duration corresponding to the target chapter based on the duration of the audio files corresponding to all the text segments; and
displaying the audio playing progress based on the played time length and the standard duration.

13. The method according to claim 9, wherein after the displaying audio playing progress based on the estimated total audio playing duration, the method further comprises:
adjusting the playing progress of the audio file being played currently in response to a triggering operation for the audio playing progress.

14. The method according to claim 13, wherein the adjusting the playing progress of the audio file being played currently in response to a triggering operation for the audio playing progress comprises:
determining a playback time point corresponding to an end operation point of the triggering operation;
if detecting that the audio file corresponding to the playback time point is comprised in the audio list, determining a first target playback time point corresponding to the playback time point in the audio file corresponding to the playback time point; and
controlling the player to start playing the audio file corresponding to the playback time point from the first target playback time point.

15. The method according to claim 14, wherein if detecting that the audio file corresponding to the playback time point is not comprised in the audio list, the method further comprises:
playing the audio file based on the playing progress before the triggering operation is executed.

16. An audio conversion apparatus, comprising:
at least one processor; and
at least one memory communicatively coupled to the at least one processor and storing instructions that upon execution by the at least one processor cause the apparatus to:
receive an audio acquisition request corresponding to a target chapter;
in response to an absence of an audio file corresponding to the target chapter, segment the target chapter to obtain a plurality of text segments;
generate an audio file corresponding to each of the text segments, and determine identification information of the audio file based on a typesetting order of each of the text segments in the target chapter, and store the audio file corresponding to each of the text segments, and generate an audio list based on file information of the audio file corresponding to each of the text segments and the identification information of the audio file; and
determine an estimated total audio playing duration corresponding to the target chapter, and send the audio list and the estimated total audio playing duration to a user terminal.

17. An audio playing apparatus, comprising:
at least one processor; and
at least one memory communicatively coupled to the at least one processor and storing instructions that upon execution by the at least one processor cause the apparatus to:
initiate an audio acquisition request corresponding to a target chapter to a server;
receive an audio list and an estimated total audio playing duration corresponding to the target chapter returned by the server, and control a player to play an audio file corresponding to each of the text segments sequentially based on the audio list, wherein the audio list comprises file information and identification information of audio files corresponding to a plurality of text segments, and the text segments are obtained by segmenting the target chapter; and
play the audio files based on the identification information of the audio files, and display audio playing progress based on the estimated total audio playing duration.

18. (canceled)

19. (canceled)
